(19) United States
(12) Patent Application Publication
(10) Pub. No.: US 2020/0082360 A1
(43) Pub. Date: Mar. 12, 2020

(54) SYSTEMS AND METHODS FOR IMPLEMENTING A SMART STABLECOIN AND FACILITATING THE TRUSTLESS SMART SWAP OF CRYPTOCURRENCY

(71) Applicant: Jointer, Inc., Los Altos, CA (US)

(72) Inventor: Yehuda Gavrielov REGEV, Los Altos, CA (US)

(73) Assignee: Jointer, Inc., Los Altos, CA (US)

(21) Appl. No.: 16/400,552

(22) Filed: May 1, 2019

Related U.S. Application Data
(60) Provisional application No. 62/728,212, filed on Sep. 7, 2018.

(51) Int. Cl. G06Q 20/06; G06Q 40/04

(52) U.S. Cl. CPC G06Q 20/065; G06Q 40/04

(57) ABSTRACT

The systems and methods described herein are related to an improved cryptocurrency stability protocol and mechanism for facilitating the exchange of cryptocurrency. The improved technology protocol described herein may comprise a stability protocol utilized to stabilize the price of a stable coin (or crypto-token) in circulation by preventing the exchange of the stable coin above or below the current value of the coin at any given time. Unlike other stable coins, the stable coin described herein may not use a currency peg or collateral or any predicting method to ensure stability. The stability protocol may instead be based on a smart contract algorithm that is designed to completely eliminate the possibility for any volatility in the first place. The improved mechanism for facilitating the exchange of cryptocurrency described herein may enable a true 1:1 value swap between two cryptocurrencies (i.e., a “smart swap”).

### CROSS-REFERENCE TO RELATED APPLICATIONS

This application claims priority to U.S. Provisional Patent Application No. 62/728,212, filed Sep. 7, 2018, which is hereby incorporated by reference in its entirety.

### FIELD OF THE INVENTION

The invention relates to an improved cryptocurrency stability protocol and mechanism for facilitating the exchange of cryptocurrency.

### BACKGROUND OF THE INVENTION

Various cryptocurrencies are known. One of the leading ones is Bitcoin. Bitcoin is a currency used in the bitcoin network, which is a peer-to-peer payment network that operates on a cryptographic protocol using a distributed ledger technology. The protocol is described in a white paper entitled “Bitcoin: A Peer-to-Peer Electronic Cash System.” The bitcoin blockchain is one example of a decentralized, distributed ledger technology. Other cryptocurrencies, blockchains and distributed ledgers are known.

Various problems exist with the protocols of these cryptocurrencies and the technology behind them. One of the problems with this technology is that there typically is no technical mechanism to ensure price stability, resulting in a high level of price volatility. Volatility for currency is typically created by one user willing to exchange an amount of that currency above or below the market value in exchange for another currency. Although some systems attempt to achieve price stability by combating volatility, these systems are not able to ensure a truly “stable” coin because a source of volatility in the future may not be known. Additionally, these systems do not address a run on bank scenario in which multiple redemptions can cause the price to crash or a rapidly rise. Other problems and technical limitations with this and other cryptocurrency protocols are well-known.

For various reasons, an entity may wish to exchange from one currency to another. To date, the most common way to exchange cryptocurrency for another cryptocurrency is to buy and sell on an exchange. Exchanges may be centralized (e.g., Coinbase or Robinhood) or decentralized where transactions are conducted “peer-to-peer.” In the case of a centralized exchange, users must have a level of trust in the exchange, specifically given that these exchanges have been prone to attacks by bad actors or mismanagement of users' assets. Further, in exchange transactions swapping one crypto for another, users typically incur fees and a spread across buy/sell prices. For these and other reasons, it is typically not possible to be assured of a true 1:1 value swap between two cryptocurrencies. These and other problems exist with conventional mechanisms for exchanging currency.

### SUMMARY OF THE INVENTION

One aspect of the invention relates to an improved technology protocol with electronic smart contracts encoding automatically executing computer-executed rules for cryptocurrency. The improved technology protocol may comprise a stability protocol utilized to stabilize the price of a stable coin (or crypto-token) in circulation by preventing the exchange of the stable coin above or below the current value of the coin at any given time. Unlike other stable coins, the stable coin described herein may not use a currency peg or collateral or any predicting method to ensure stability. The stability protocol may instead be based on a smart contract algorithm that is designed to completely eliminate the possibility for any volatility in the first place. This is achieved by preventing the user from selling the stable coin above or below the current (fixed) face value.

In various implementations, the stability protocol is designed to process a two-way transaction. On one side the sender can send the stable coin to a receiver, but on the other side the receiver must send back in return cryptocurrency or, an invoice, or receipt with same value as the stable coin. In the event that the value of the exchange does not match, the smart contract may be configured to balance the face value between the sender and the receiver by returning the extra value to whom it belongs. The two-way nature of the smart contract means that the stable coin cannot be traded speculatively, since the value of the stable coin is enforced.

By using a smart contract to prevent the exchange of the cryptocurrency above or below its face value, the stability protocol is able to remove the volatility created by these exchanges, thereby stabilizing the value of the cryptocurrency. As used herein, the term “stable” in regard to crypto-tokens described herein is also intended to mean that the purchasing power or value remains stable over time such as to account for inflation (or deflation). Thus, while the “price” of the stable crypto-token may change over time, the improved technology protocol will preserve the value or purchasing power of the crypto-token even during such price changes.

Another aspect of the invention relates to an improved mechanism for facilitating the exchange of cryptocurrency. In various implementations, the improved mechanism for facilitating the exchange of cryptocurrency may enable a true 1:1 value swap between two cryptocurrencies. This aspect of the invention will be referred to as a “smart swap.” One characteristic of the smart swap is that it is neither truly a centralized exchange nor just a peer-to-peer exchange. Rather, it is a peer-to-community solution. This provides users with an affordable, trustless mechanism to exchange one cryptocurrency for another cryptocurrency without the need to surrender their coin to an exchange hot wallet or be concerned with market volatility to prevent losses. Furthermore, the users are guaranteed to have an exact face value to face value (i.e., 1:1) match, making a crypto-to-crypto swap precise, low risk, and 100% fee-free.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The drawings are provided for purposes of illustration only and merely depict typical or example implementations. These drawings are provided to facilitate the reader's understanding and shall not be considered limiting of the breadth, scope, or applicability of the disclosure. For clarity and ease of illustration, these drawings are not necessarily drawn to scale.

FIG. 1 illustrates an example of a system for implementing a cryptocurrency protocol for stabilizing a cryptocurrency, according to an implementation of the invention.

FIG. 2 illustrates an example of a node in a cryptocurrency network that implements the cryptocurrency protocol, according to an implementation of the invention.

FIG. 3 illustrates an example of the two-way nature of the stability protocol, according to an implementation of the invention.

FIGS. 4-7 illustrate example use cases of the smart swap mechanism configured to facilitate the exchange of cryptocurrency, according to an implementation of the invention.

FIG. 8 illustrates an example of a process of stabilizing a cryptocurrency using a stability protocol, according to an implementation of the invention.

### DETAILED DESCRIPTION OF THE INVENTION

The systems and methods described herein relate to an improved cryptocurrency stability protocol and mechanism for facilitating the exchange of cryptocurrency. In various implementations, the systems and methods described herein may implement a cryptocurrency protocol with built-in interventive response mechanisms to stabilize the value of a cryptocurrency. In various implementations, the cryptocurrency protocol may comprise a stability protocol. The stability protocol may comprise a new algorithmic methodology that eliminates the ability to sell the cryptocurrency managed by the protocol above or below the set price. In various implementations, the cryptocurrency protocol may be designed to overcome inflation.

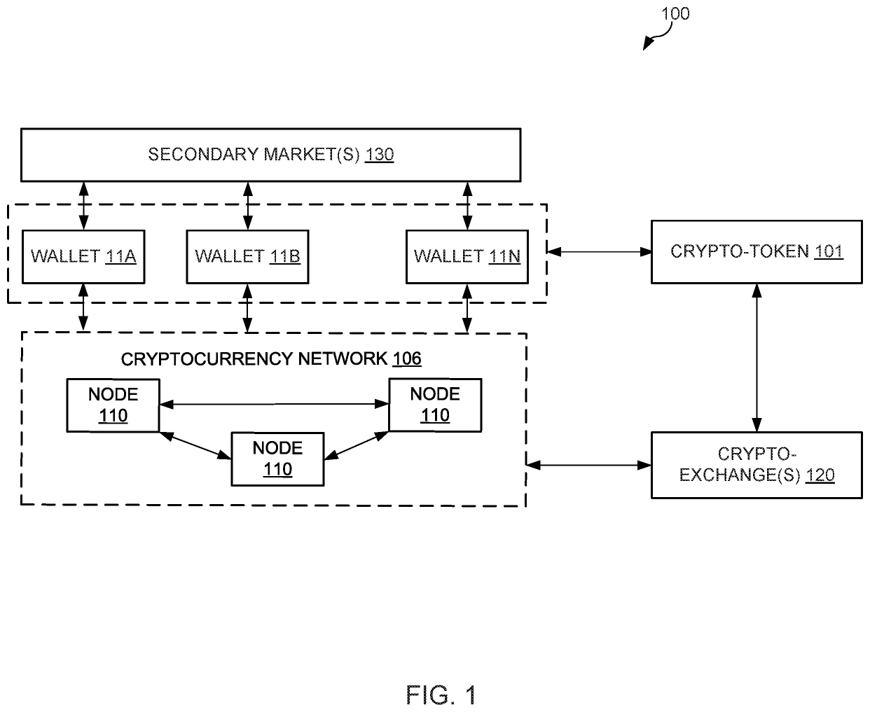

FIG. 1 illustrates an example of a system 100 for implementing a cryptocurrency protocol for stabilizing a crypto-token 101, according to an implementation of the invention. As used herein, the term “stable coin” may also be used to describe crypto-token 101. In various implementations, crypto-token 101 is electronic data that represents a unit of value that may be transferred to various electronic blockchain wallets 11 (illustrated as wallets 11A-N). Such transfer represents circulation of the crypto-token 101. For instance, the holder of a crypto-token 101 may transfer a unit (including fractions, multiples, etc.) of crypto-token 101 from the holder's wallet (e.g., wallet 11A) to the wallet of another (e.g., wallet 11B). This may be accomplished by a blockchain transaction that is validated and recorded on a decentralized ledger of the cryptocurrency network 106. To stabilize the price of the crypto-token 101, the cryptocurrency network 106 may include multiple blockchain computer nodes 110 (hereinafter referred to as “node 110” or “nodes 110”) that each implement the cryptocurrency protocol described herein. System 100 may include one or more other components described below.

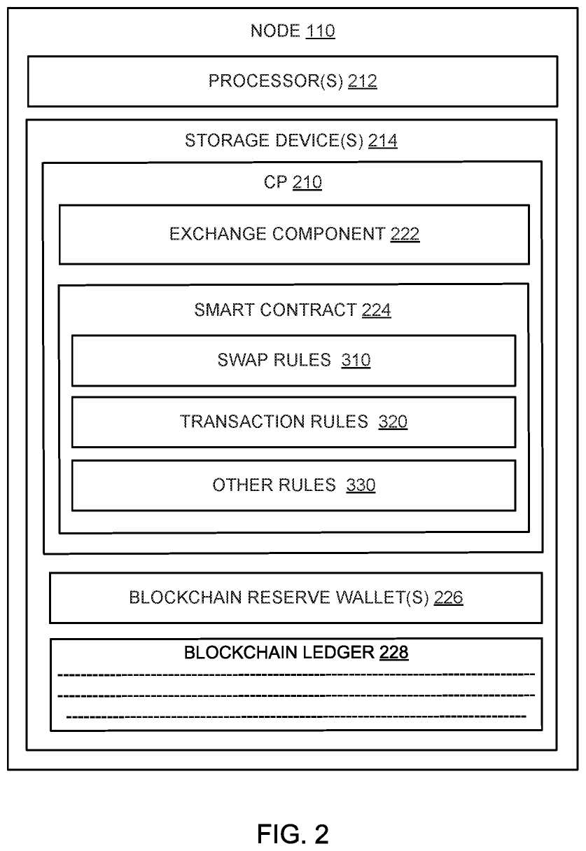

FIG. 2 illustrates an example of a node 110 in a cryptocurrency network 106 that implements the cryptocurrency protocol, according to an implementation of the invention. In various implementations, each node 110 may include one or more processors 212 programmed by computer program instructions stored at one or more storage devices 214. The storage devices 214 may store the cryptocurrency protocol 210 (“CP 210”), which may include a protocol agent that automatically executes a smart contract 224. Each node 110 may store a blockchain ledger 228. The blockchain ledger 228 is a decentralized ledger, a copy of at least a portion or all of which is stored at each node 110. The blockchain ledger 228 may store transactions described herein. Such transactions may include the transfer of crypto-tokens 101, asset token sales, and/or other transactions.

The protocol agent of the CP 210 may automatically enforce the smart contract 224, which may encode one or more rules. These rules may include data, machine-executable code, and/or other information that specifies actions that should be taken. For instance, the rules may include, without limitation, swap rules 310, transaction rules 320, and/or other rules 330. In some implementations, other rules 330 may include crypto-token valuation rules and/or other rules for implementing a cryptocurrency protocol described in U.S. Provisional Patent Application No. 62/728,212, filed Sep. 7, 2018, the disclosure of which is hereby incorporated by reference in its entirety herein. When a system function is described herein, such as when the protocol agent and/or smart contract 224 are described as performing a function, this function may be performed by one or more nodes 110 automatically by consulting the appropriate rule from the smart contract 224. As such, the decision making of the cryptocurrency protocol 210 may be made in a decentralized fashion, driven by automated execution of the smart contract 224.

Stability Protocol

In various implementations, the stability protocol may be utilized to stabilize the price of crypto-token 101 in circulation by preventing the exchange of crypto-token 101 above or below the current value of crypto-token 101 at any given time. Volatility for currency is typically created by one user willing to exchange an amount of that currency above or below the market value in exchange for another currency. By using a smart contract to prevent the exchange of the cryptocurrency above or below its face value, the stability protocol is able to remove the volatility created by these exchanges, thereby stabilizing the value of the cryptocurrency.

Unlike other stable coins, cryptocurrency generated and/or managed via system 100 (i.e., crypto-token 101) may not use a currency peg or collateral or any predicting method to ensure stability. The stability protocol may instead be based on a smart contract algorithm that is designed to completely eliminate the possibility for any volatility in the first place. This is achieved by preventing the user from selling crypto-token 101 above or below the current (fixed) face value. Unlike all other cryptocurrencies that can process a one-way transaction, the stability protocol is designed to process a two-way transaction. On one side the sender can send crypto-token 101 to a receiver but on the other side the receiver must send back in return cryptocurrency or, an invoice or receipt with same value as crypto-token 101. In the event that the value of the exchange does not match, the smart contract may be configured to balance the face value between the sender and the receiver by returning the extra value to whom it belongs. The two-way nature of the smart contract means that crypto-token 101 cannot be traded speculatively, since the value of crypto-token 101 is enforced.

For example, if a first user pays $80 using cryptocurrency such as Bitcoin or ETH to purchase an amount of crypto-token 101 from a second user at $100 fixed face value, the smart contract (e.g., smart contract 224) will send to the first user only 80% of crypto-token 101 ($80/$100)—the remaining 20% will be returned back to the second user's wallet. The smart contract(s) work the same way when using crypto-token 101 to buy or exchange for one or more other items of value—the invoice or the receipt for the items of value must be equivalent or less to the fixed face value of crypto-token 101. If the values do not match, smart contract will adjust to ensure that they do. As used herein, one or more items of value may comprise one or more units of cryptocurrency, one or more units of another currency, one or more goods and/or services, and/or other items of value.

In an example implementation, if a buyer purchases ten crypto-tokens 101 worth $1,000 and the buyer sends the seller cryptocurrency equal to $800, the smart contract may be configured to cause the buyer to receive only 80% of the crypto-tokens 101 ($800/$1,000). Based on the stability protocol described herein, the remaining 20% (i.e., the amount above or below the face value of crypto-token 101) will be returned. In this example, the smart contract may cause the remaining 20% to be returned to the seller. In another example implementation, if a buyer purchases ten crypto-tokens 101 worth $1,000 and the buyer sends the seller cryptocurrency equal to $1,200, the smart contract may be configured to cause the seller to receive only $1,000 in exchange for the ten crypto-tokens 101. The smart contract may cause the remaining $200 to be returned to the buyer.

To further protect the system from abuse, the smart contract will implement a payload method function that runs across blockchain networks. This acts in the same way as an attachment on an email. Each block in the transaction chain will have an attachment or “payload.” The information contained in the payload will be similar to the amount, receipt, or invoice. This payload will allow a smart contract to verify and confirm the value of cryptocurrency and/or goods and services to be exchanged for one or more crypto-tokens 101 are equal to the face value of the one or more crypto-tokens 101 being sent.

The protocol agent of the CP 210 may automatically enforce the smart contract 224, which may encode one or more rules for implementing the stability protocol described herein. For example, the one or more rules may include swap rules 310, transaction rules 320, and/or other rules 330 for implementing a cryptocurrency protocol. In various implementations, swap rules 310 may be configured to administer exchanges of crypto-token 101 for an amount of one or more other cryptocurrencies and/or other items of value. In various implementations, system 100 may be configured to receive a request to exchange crypto-token 101 for an amount of another cryptocurrency and/or one or more other items of value. For example, a request to exchange crypto-token 101 may indicate an amount of crypto-token 101 to be exchanged for an amount of another cryptocurrency, an amount of another currency, and/or another item of value. In various implementations, swap rules 310 may specify that crypto-token 101 may only be exchanged at its current face value. For example, swap rules 310 may specify that crypto-token 101 may only be exchanged for an amount of another cryptocurrency (or other currency) equal to the value of the amount of crypto-token 101 to be exchanged. In another example, swap rules 310 may specify that crypto-token 101 may only be exchanged for an item of value equal to the value of the amount of crypto-token 101 to be exchanged.

In various implementations, each time crypto-token 101 is transferred from one wallet (e.g., wallet 11A) to another wallet (e.g., wallet 11B), the transfer (or transfer request) is automatically received by smart contract 224. In other words, each transfer of crypto-token 101 must go through smart contract 224. In various implementations, smart contract 224 may be configured to determine a value of the other cryptocurrency (or other currency) or item of value to be exchanged for an amount of crypto-token 101. Based on the value of the other cryptocurrency (or other currency) or item of value to be exchanged for an amount of crypto-token 101, smart contract 224 may be configured to automatically cause a portion of the crypto-token 101 or a portion of the cryptocurrency (or other currency) or item of value to be returned. In various implementations, smart contract 224 may enable the exchange to occur at the value of the crypto-token 101 (i.e., process the transaction for the amount of the other cryptocurrency, currency, and/or other item of value based on the value of crypto-token 101 to be exchanged). However, in some implementations, the smart contract will return the crypto-token 101 above or below the value of the cryptocurrency and/or goods and services to be exchanged. In other implementations, the smart contract will return the cryptocurrency and/or goods and services above or below the value of crypto-token 101 to be exchanged.

In some instances, users may attempt to game the system by asserting they are providing services or certain goods in exchange for crypto-tokens 101 but in fact are buying crypto-tokens at reduced value. For example, a first user may receive 10 crypto-tokens 101 from a second user and claim that the first user is providing a service or goods to the second user valued at 10 crypto-tokens. In fact, the first user may provide services or goods with a value less than 10 crypto-tokens (or no service or goods at all). Doing so devalues each crypto-token. To mitigate this scenario, the system may impose a receipt system in which the transactions are recorded. Such recordation may occur on the blockchain, such as on a decentralized ledger of the cryptocurrency network 106. In this way, users providing such services or goods may be obligated to report the transactions/earnings to tax or other government authorities, reducing the incentive to cheat.

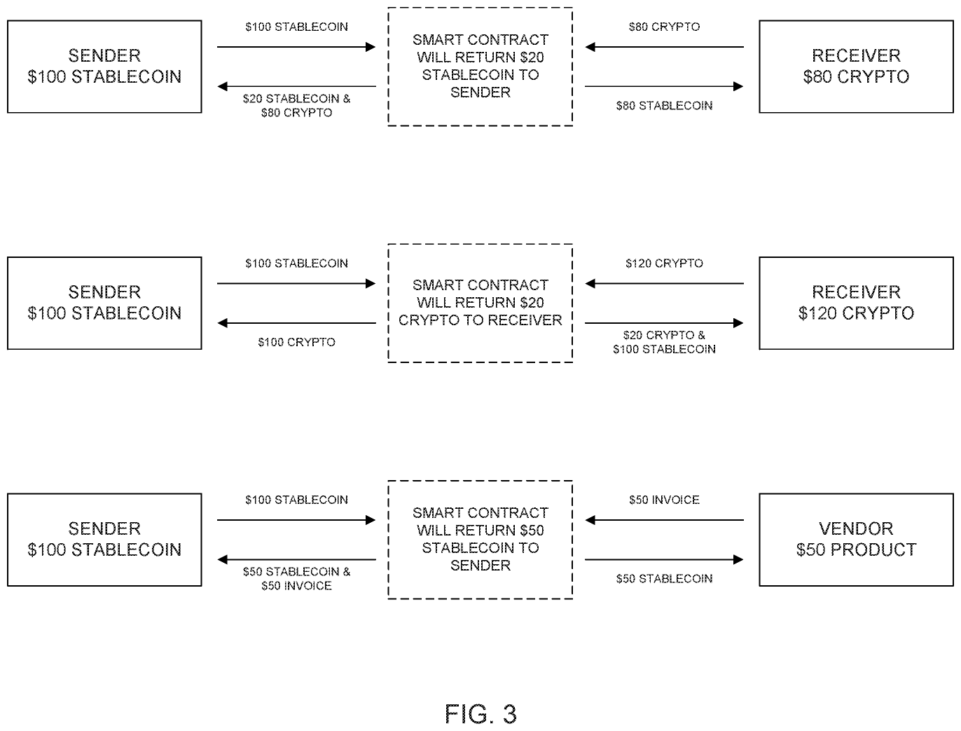

FIG. 3 illustrates an example of the two-way nature of the stability protocol, according to an implementation of the invention. In an example implementation, a transaction may be received in which a sender elects to exchange, with a receiver, $100 of crypto-token 101 for $80 of another cryptocurrency. In the foregoing instance, smart contract 224 may be configured to process the exchange of $80 of crypto-token 101 for $80 of the other cryptocurrency. However, the exchange of the crypto-token above its face value will be denied. Smart contract 224 may be configured to return the excess $20 crypto-token 101 to the sender. In an example implementation, a transaction may be received in which a sender elects to exchange, with a receiver, $100 of crypto-token 101 for $120 of another cryptocurrency. In the foregoing instance, smart contract 224 may be configured to process the exchange of $100 of crypto-token 101 for $100 of the other cryptocurrency, but return the excess $20 of the other cryptocurrency to the receiver, thereby ensuring crypto-token 101 is not exchanged above (or below) its face value. In another example implementation, a transaction may be received in which a sender elects to exchange, with a vendor, $100 of crypto-token 101 for a product valued at $50. In the foregoing instance, smart contract 224 may be configured to process the exchange of $50 of crypto-token 101 for the product valued at $50. However, the smart contract 224 may be configured to return the excess $50 of crypto-token 101 to the sender, thereby ensuring crypto-token 101 is not exchanged above (or below) its face value. Accordingly, the stability protocol implemented via a smart contract (i.e., smart contract 224) may be configured to prevent the exchange of crypto-token 101 above or below the current value of crypto-token 101 at any given time in a two-way manner.

In various implementations, the cryptocurrency protocol (i.e., cryptocurrency protocol 210) may comprise the stability protocol described herein and/or a liquidity protocol. The liquidity protocol may comprise a new methodology to survive cryptocurrency crises through the use of a hybrid collateralized/non-collateralized protocol, dynamically managed by machine learning based on the fractionalized reserve multiplier effect. For example, cryptocurrency protocol 210 may comprise a liquidity protocol similar to the liquidity protocol described in U.S. Provisional Patent Application No. 62/728,212, filed Sep. 7, 2018, the disclosure of which is hereby incorporated by reference in its entirety herein.

In some implementations, the systems and methods described herein may be configured to stabilize the value of a cryptocurrency utilizing a cryptocurrency protocol that includes both the stability protocol and the liquidity protocol, or one or more elements of the stability protocol and one or more elements of the liquidity protocol. In other implementations, the systems and methods described herein may be configured to stabilize the value of a cryptocurrency utilizing a cryptocurrency protocol that includes either the stability protocol or the liquidity protocol. In other words, the stability protocol and liquidity protocol may be configured to operate independently and may not depend from one another. Accordingly, each of the stability protocol and the liquidity protocol may comprise independent mechanisms utilized by the systems and methods described herein.

Smart Swaps

In various implementations, the systems and methods described herein may be configured to facilitate the exchange of cryptocurrency. For example, the systems and methods described herein may include an improved mechanism for facilitating the exchange of cryptocurrency. The improved mechanism may enable a true 1:1 value swap between two cryptocurrencies. This may be referred to herein as “smart swap.” One characteristic of the smart swap is that it is neither truly a centralized exchange nor just a peer-to-peer exchange. Rather, it is a peer-to-community solution. This provides users with an affordable, trustless mechanism to exchange one cryptocurrency for another cryptocurrency without the need to surrender their coin to an exchange hot wallet or be concerned with market volatility to prevent losses. Furthermore, the users are guaranteed to have an exact face value to face value (i.e., 1:1) match, making a crypto-to-crypto swap precise, low risk, and 100% fee-free.

As described herein, each node 110 may include one or more processors 212 programmed by computer program instructions stored at one or more storage devices 214. In various implementations, the computer program instructions may include an exchange component 222 configured to administer a cryptocurrency exchange. In various implementations, the cryptocurrency exchange administered by exchange component 222 may comprise a smart swap exchange through which a user may identify an amount of a first type of cryptocurrency to exchange for a second type of cryptocurrency. Rather than specifying the amount of the second type of cryptocurrency, user input may specify merely the amount of the first type of cryptocurrency to be exchanged and the second type of cryptocurrency the user elects to receive. Based on the value of the first type of cryptocurrency, the smart swap exchange may automatically identify a second user who wishes to exchange the amount of the second type of cryptocurrency equal in value to the amount of the first type of cryptocurrency. However, a user may not be able to indicate the value at which they wish to sell their cryptocurrency. Notably, the improved mechanism described herein may not ask a user the value at which the user wishes to buy or sell their cryptocurrency. Rather, the mechanism described herein may query the user to receive input indicating merely that the user wishes to exchange (or swap) a value of one cryptocurrency for an amount of another cryptocurrency at the same value.

With conventional cryptocurrency exchanges, when a user needs to change one crypto for another, they must have an account on an exchange. In order to make their exchange they must accept the best price they can find from other traders. Further, if a coin changes in value, the exchange does not adjust the trade to accommodate this; users are constantly expose for a risk of losing in trades because of market volatility. Today users must watch the market to make sure that their trades are not impacted by fluctuations. In an example implementation using existing cryptocurrency exchanges, a user may initiate an order to trade 1 unit of a first type of cryptocurrency (e.g., 1 BTC) for 30 units of a second type of cryptocurrency (e.g., 30 ETH). At the time the order, the first type of cryptocurrency may be valued at $4,000 and the second type of cryptocurrency may be valued at ˜$133. However, if the value of the second type of cryptocurrency drops in value by 5%, the user would still receive 30 units, but the value of those 30 units would be $3,800 instead of $4,000. Accordingly, the user would lose $200. Alternatively, if the value of the first type of cryptocurrency increases in value by 5% (e.g., to $4,200), the user would lose this gain in the trade as they will still only receive 30 units of the second type of cryptocurrency.

In an example implementation using the smart swap exchange administered by exchange component 222, a user may instead initiate an order to trade 1 unit of one type of cryptocurrency (e.g., 1 BTC) for a second type of cryptocurrency. In other words, a user may initiate an order to exchange an amount of one type of cryptocurrency for a second type of cryptocurrency without specifying the amount of the second type of cryptocurrency the user is to receive. If at the time the order is processed the second type of cryptocurrency is valued at ˜$133, the user would still receive 30 units. However, if the value of the second type of cryptocurrency drops in value by 5%, the user would instead receive 31.578 units of the second type of cryptocurrency (e.g., 31.578 ETH) worth a total of $4,000 (i.e., the value of the 1 unit of the first type of cryptocurrency). If the value of the first type of cryptocurrency increases in value by 5% (e.g., to $4,200), the user would instead receive 31.5 units of the second type of cryptocurrency (e.g., 31.5 ETH) worth a total of $4,200 (i.e., the increased value of the 1 unit of the first type of cryptocurrency).

In various implementations, the smart swap exchange may be administered through system 100. In some implementations, the smart swap exchange may be administered through a SmartSwap system accessed via a website. In various implementations, transfers may be performed through the smart swap exchange via metamask and/or one or more other cryptocurrency wallets. In various implementations, a buyer and seller may exchange cryptocurrency by transferring their tokens or currency to a SmartSwap contract address. Upon receiving tokens or currency, a SmartSwap smart contract may be configured to process a request to swap one or more types of cryptocurrency. For example, SmartSwap smart contract may be configured to calculate the value of the tokens or currency received and transfer tokens or currency to the buyer or seller as described herein. In various implementations, a user that submits a request to swap one or more types of cryptocurrency (i.e., swap a first type of cryptocurrency for a second type of cryptocurrency) via an exchange administered by the SmartSwap smart contract may be required to send or otherwise transmit the first type of cryptocurrency to be exchanged. The SmartSwap smart contract may cause the transmitted first type of cryptocurrency to be locked at a smart contract address. The locked tokens may not release the tokens to the other side unless a match is found or may only release a portion of the tokens responsive to the identification of a user willing to swap only the second type of cryptocurrency for only a portion of the locked tokens. In other words, there is no wallet required to hold the tokens awaiting transfer from one user to another via the SmartSwap exchange. In various implementations, a user transferring (or exchanging) tokens or currency via a SmartSwap system accessed via a website may view completed and/or pending transfers (or exchanges) via the website.

In various implementations, the exchange component 222 may be configured to generate one or more graphical user interfaces to be presented via a display of a user device. The one or more graphical user interfaces may facilitate the smart swap exchange. For example, exchange component 222 may be configured to generate one or more graphical user interfaces configured to receive user input indicating the amount of a first type of cryptocurrency to be exchanged and a second type of cryptocurrency to be received. In various implementations, the one or more graphical user interfaces do not enable a user to indicate a value at which to exchange the amount of the first type of cryptocurrency. In various implementations, the one or more graphical user interfaces do not enable a user to indicate an amount of the second type of cryptocurrency to be received. Accordingly, the graphical user interfaces do not enable a user to specify the value at which to exchange a first type of cryptocurrency. Based on the amount of the first type of cryptocurrency indicated and the specified second type of cryptocurrency to be received, exchange component 222 may be configured to identify a user willing to trade an amount of the second type of cryptocurrency for at least the portion of the amount of the first type of cryptocurrency sought to be exchanged based on the request.

As described above, the smart swap exchange administered by exchange component 222 may enable a user to receive an exact value match (i.e., a 1:1 value swap). The peer-to-community element may also enable a user to trade openly with an entire community. In other words, the peer-to-community element refers to the smart swap exchange enabling a user to submit a request to swap $100 (i.e., of a first type of cryptocurrency), and the smart swap exchange may be configured to identify another user willing to swap. If the other user is only willing to swap 75% of the requested amount (i.e., $75 worth of a second type of cryptocurrency for $75 worth of the first type of cryptocurrency), the smart swap mechanism may be configured to swap the $75 of the first type of cryptocurrency for the $75 worth of the second type of cryptocurrency. The smart swap mechanism may be configured to cause the requesting user to keep the remaining 25% (i.e., the $25 worth of the first type of cryptocurrency not swapped) as pending cryptocurrency to be exchanged when a user willing to swap is identified The smart swap exchange may also enable a user to trade without hot wallets, sharing accounts or private data, deposits, and/or required inventory; and/or do so 100% fee-free. As such, a user is able to exchange cryptocurrency for cryptocurrency without the risk, hassle, expense, or volatility that exist on other cryptocurrency exchanges.

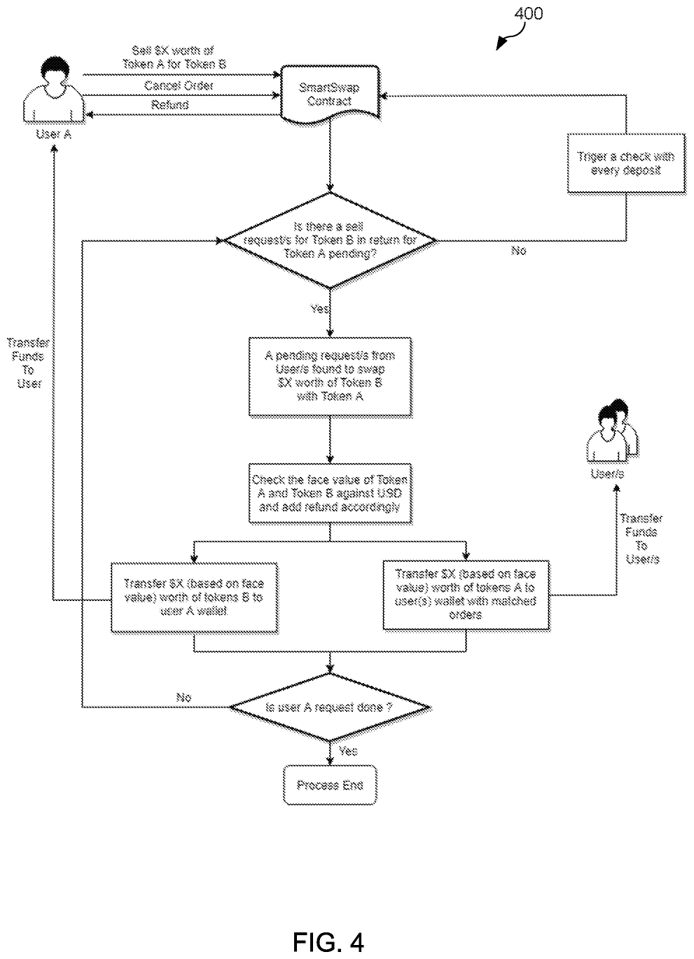

FIG. 4 illustrates an example use case 400 of the smart swap mechanism configured to facilitate the exchange of cryptocurrency, according to an implementation of the invention. In example use case 400, the SmartSwap smart contract configured to process a request to swap one or more types of cryptocurrency may receive a request from a first user (i.e., User A) via the SmartSwap exchange to trade $100 worth of a first type of cryptocurrency (i.e., token A) for $100 worth of a second type of cryptocurrency (token B). The SmartSwap smart contract may be configured to receive the order to sell $100 of token A for $100 of token B with a deposit of $100 worth of token A. The SmartSwap smart contract may be configured to check the amount of token A needed to cover $100. The SmartSwap smart contract may be configured to check the SmartSwap exchange to identify if there are any sell requests for token B in exchange for token A pending on the SmartSwap exchange or on the backend. For example, to process a swap involving User A and User B, both User A and User B may be required to interact with the SmartSwap exchange. If there are no token B sell requests that also demand token A in return, then a check of the deposit and value may be performed, and the SmartSwap smart contract may be configured to re-attempt to settle the swap. If the SmartSwap smart contract identifies pending requests matching the order of User A, the SmartSwap smart contract may be configured to execute the trade. The face value received by the SmartSwap smart contract as a result of its trade with User B to receive token B is then valued in dollars based on market rates. Likewise, the value of the exchanged token A may be valued in dollars based on market rates. In the event the value of the token A to be exchanged increases from $100 to $110, the SmartSwap smart contract may be configured to ensure User A receives $110 worth of token B—i.e., the equivalent amount of token B equal to the face value of token A. If the SmartSwap smart contract has not been fully executed and more of the initially deposited tokens remain to be exchanged, the SmartSwap smart contract may be configured to return to the exchange or backend to identify more matching trades in order to repeat the process until the order of User A is completely fulfilled. As long as the order remains pending, a user may be able to cancel the swap and ask for a refund of any remaining amount of token A that has not yet been swapped for token B. Once the order of User A has been fulfilled and the appropriate tokens have been issued out to all the users involved in the transaction, the SmartSwap smart contract may be configured to terminate the operation based on the received request. User A may also cancel the order and receive a refund, or User A may receive a refund for excess token A deposited.

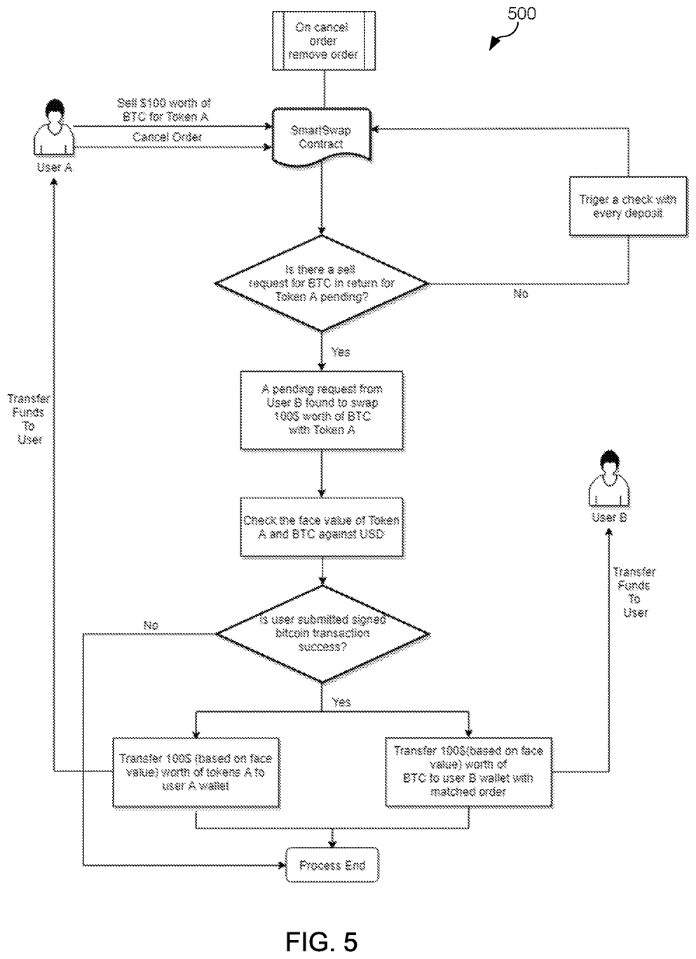

FIG. 5 illustrates an example use case 500 of the smart swap mechanism configured to facilitate the exchange of cryptocurrency, according to an implementation of the invention. In example use case 500, the SmartSwap smart contract configured to process a request to swap one or more types of cryptocurrency may receive a request from a first user (i.e., User A) to trade $100 worth of a first type of cryptocurrency (i.e., BTC) for $100 worth of a second type of cryptocurrency (token A). The SmartSwap smart contract may be configured to receive the order to sell $100 of BTC for $100 of token A with a deposit of $100 worth of BTC. The SmartSwap smart contract may be configured to check the amount of BTC needed to cover $100. The SmartSwap smart contract may be configured to check the exchange to identify if there are any sell requests for token A in exchange for BTC pending on the exchange or on the backend. If there are no token A sell requests that also demand BTC in return, a check of the deposit and value may be performed, and the SmartSwap smart contract may be configured to re-attempt to settle the swap. If a pending request (by User B) is found to settle BTC for token A, the SmartSwap smart contract may be configured to check the face value of the token A and BTC against the dollar (and/or other currency). The SmartSwap smart contract may be configured to attempt the exchange, and if successful, transfer an appropriate amount of tokens/BTC to User A and User B in the amount corresponding to $100 at face value of BTC and token A. If the exchange of BTC is not successful (e.g., the BTC is not authenticated by the blockchain), the SmartSwap smart contract may be configured to terminate (preferably with an informative error notice to User A). If the full $100 of BTC is exchanged, the SmartSwap smart contract may be configured to terminate the operation based on the received request once the tokens and BTC have been distributed. The SmartSwap smart contract may also be configured to accept cancellations at any time, which may trigger the SmartSwap smart contract to remove any requested orders from the backend or exchange.

In implementations involving BTC transactions (e.g., example use case 500), the BTC coins may not be sent to the smart contract address themselves as there is no smart contract on the Bitcoin network. Instead, a signed transaction of the BTC coins may be sent to the smart contract address. Once a user is identified that is willing to swap another type of cryptocurrency for the BTC coins, the SmartSwap smart contract may be configured to check in real-time that the user has enough BTC coins in their wallet that match the signed order, and then process a full or partial swap of the BTC coins based on a determination that the user has enough BTC coins in their wallet that match the signed order.

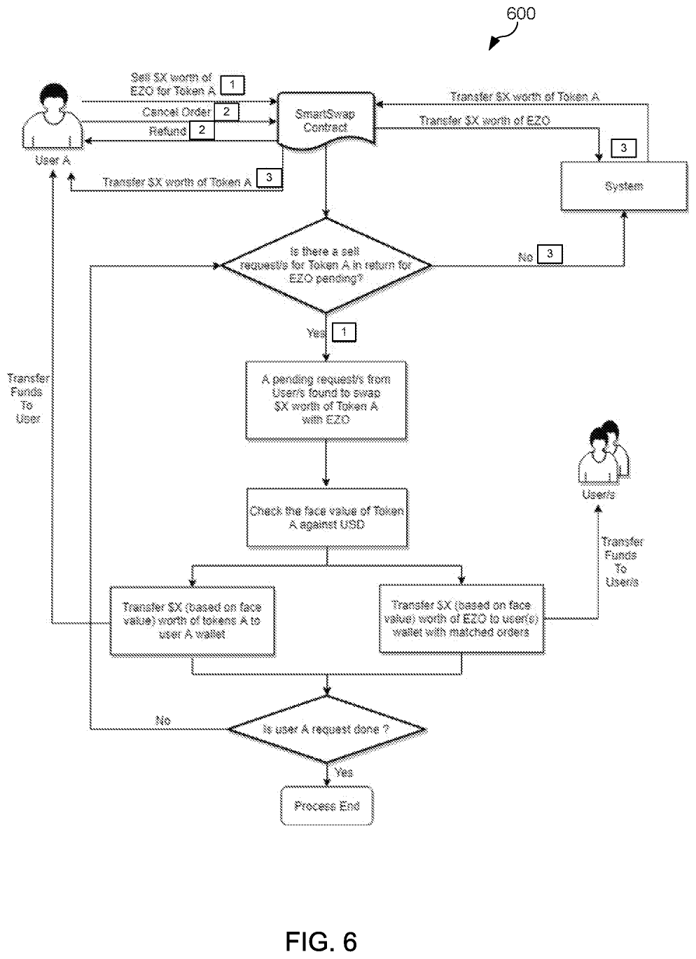

FIG. 6 illustrates an example use case 600 of the smart swap mechanism configured to facilitate the exchange of cryptocurrency, according to an implementation of the invention. In example use case 600, the SmartSwap smart contract configured to process a request to swap one or more types of cryptocurrency may receive a request from a first user (i.e., User A) to trade $100 worth of a first type of cryptocurrency (i.e., EZO) for $100 worth of a second type of cryptocurrency (i.e., token A). The SmartSwap smart contract may be configured to receive orders, cancellations of orders, and/or issue refunds. The SmartSwap smart contract may be configured to receive the order to sell $100 of EZO (or any other stablecoin implemented via or in connection with the systems and methods described herein) for $100 of token A along with a deposit (or draw) of $100 worth of EZO from the wallet of User A. Notably, the stability protocol described herein may comprise a turn-key platform enabling entities to create their own stable coin under various different names. As such, a first type of cryptocurrency referred to herein as “EZO” may in alternative embodiments comprise any stablecoin implemented via the systems and methods described herein. The SmartSwap smart contract may be configured to check the amount of EZO needed to cover $100 and ensure sufficient funds to execute the contract. The SmartSwap smart contract may be configured to check the exchange to identify if there are any sell requests for token A in exchange for EZO pending on the exchange or on the backend. If a matching or corresponding order is found, the SmartSwap smart contract may be configured to check the face value of token A in dollars and execute the swap or trade of EZO for token A. The SmartSwap smart contract may be configured to transfer $100 of token A to User A and $100 of EZO to User B. If the SmartSwap smart contract has not been fully executed and more of the initially deposited tokens remain to be exchanged, the SmartSwap smart contract may be configured to return to the exchange or backend to identify more matching trades in order to repeat the process until the order of User A is completely fulfilled. If there is no corresponding order on the exchange where User B wishes to sell token A for EZO, a liquidity system may be configured to act as the buyer/swapee of last resort. In this case, the system may be configured to use other cryptocurrencies other than the first type of cryptocurrency and the second type of cryptocurrency to trade for token A within the system. Once the system has received enough of token A to fulfill User A's order, the SmartSwap smart contract may be configured to execute the trade with User A with the system as the counterparty, and provide $100 of token A to User A. If User A cancels their order, the SmartSwap smart contract may be configured to issue a refund to User A in EZO, upon which the SmartSwap smart contract may be configured to terminate the operation commenced based on the received request.

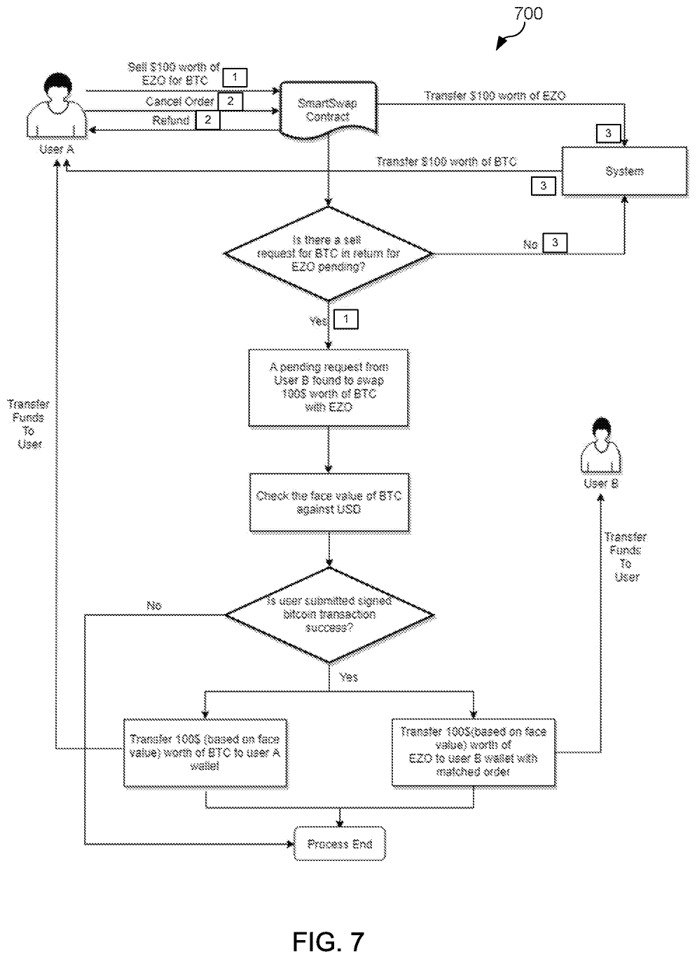

FIG. 7 illustrates an example use case 700 of the smart swap mechanism configured to facilitate the exchange of cryptocurrency, according to an implementation of the invention. In example use case 700, the SmartSwap smart contract configured to process a request to swap one or more types of cryptocurrency may receive a request from a first user (i.e., User A) to trade $100 worth of a first type of cryptocurrency (i.e., EZO) for $100 worth of a second type of cryptocurrency (i.e., BTC). The SmartSwap smart contract may be configured to receive orders, cancellations of orders, and/or issue refunds. The SmartSwap smart contract may be configured to receive the order to sell $100 of EZO for $100 of BTC along with a deposit (or draw) of $100 worth of EZO from the wallet of User A. The SmartSwap smart contract may be configured to check the amount of EZO needed to cover $100 and ensure sufficient funds in the wallet/deposit to execute the contract. The SmartSwap smart contract may be configured to check the exchange to identify if there are any sell requests for BTC in exchange for EZO pending on the exchange or on the backend. If a matching or corresponding order is found, the SmartSwap smart contract may be configured to check the face value of BTC in dollars (or other currency) and then execute the swap or trade of EZO for BTC. If the trade of BTC is authorized by the blockchain, the wallets of User A and counterparty (User B) may be updated to include the amount of $100 face value of BTC and EZO, respectively. If the trade of BTC is not authorized, the SmartSwap smart contract may be configured to terminate the operation commenced based on the received request. If there is no corresponding order on the exchange where a user B wishes to sell BTC for EZO, the system itself may be configured to act as the buyer/swapee of last resort. In this case, the system may be configured to use other cryptocurrencies besides the first type of cryptocurrency and the second type of cryptocurrency to trade for BTC within the system. Once the system has received enough BTC to fulfill User A's order, the SmartSwap smart contract may be configured to execute the trade with User A with the system as the counterparty, and provide $100 of BTC to User A. If user A cancels their order, the SmartSwap smart contract may be configured to issue a refund to User A in EZO, upon which the SmartSwap smart contract may be configured to terminate the operation commenced based on the received request.

### Exemplary Flowcharts of Processes

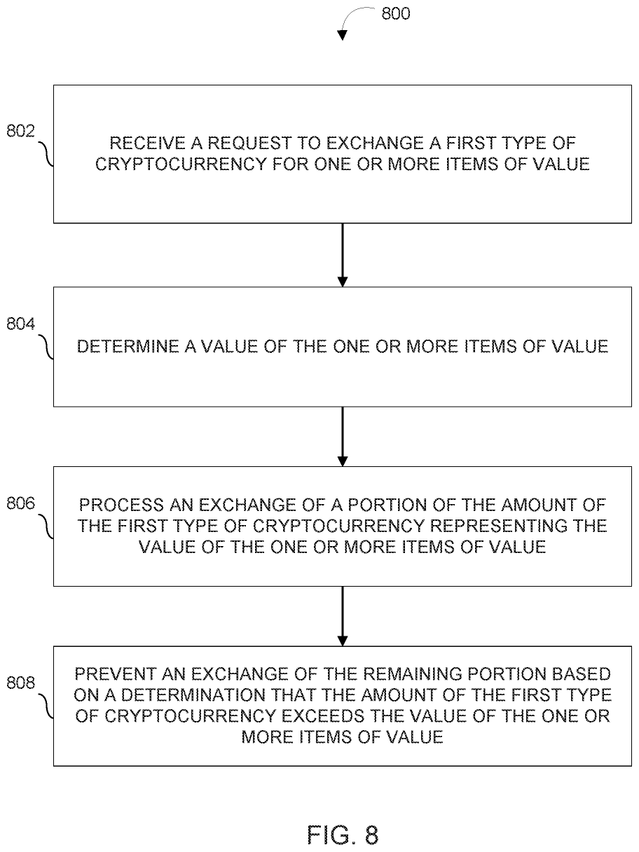

FIG. 8 illustrates an example of a process 800 of stabilizing a cryptocurrency using a stability protocol, according to an implementation of the invention. In various implementations, process 800 may be implemented via one or more smart contracts. The operations of process 800 presented below are intended to be illustrative and, as such, should not be viewed as limiting. In some implementations, process 800 may be accomplished with one or more additional operations not described, and/or without one or more of the operations discussed. In some implementations, two or more of the operations may occur substantially simultaneously. The described operations may be accomplished using some or all of the system components described in detail above.

In some implementations, process 800 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of process 800 in response to instructions stored electronically on one or more electronic storage mediums. The one or more processing devices may include one or more devices configured through hardware, firmware, and/or software to be specifically designed for execution of one or more of the operations of process 800.

In an operation 802, process 800 may include receiving a request to exchange cryptocurrency generated and/or managed by the protocol described herein for one or more items of value. The one or more items of value may comprise one or more units of cryptocurrency, one or more units of another currency, one or more goods and/or services, and/or other items of value. For example, the request received may involve the exchange of the crypto-token for another type of cryptocurrency, and the request may indicate an amount of the crypto-token (i.e., a first type of cryptocurrency) to be exchanged for the other type of cryptocurrency (i.e., a second type of cryptocurrency). In various implementations, a request received may involve the exchange of the stable cryptocurrency implemented by the stability protocol described herein. Each request involving the stable cryptocurrency may be automatically received by a smart contract configured to implement the improved cryptocurrency protocol. The smart contract configured to implement the improved cryptocurrency protocol may automatically prevent the stable cryptocurrency from being exchanged above or below its face value. In some implementations, one or more graphical user interfaces configured to receive user input may be generated. For example, the one or more graphical user interfaces may be configured to receive user input indicating the amount of a first type of cryptocurrency to be exchanged for one or more items of value, such as a second type of cryptocurrency. In some implementations, the one or more graphical user interfaces do not enable a user to indicate a value at which to exchange the amount of a first type of cryptocurrency. In some implementations, the one or more graphical user interfaces do not enable a user to indicate an amount of a second type of cryptocurrency to be received.

In an operation 804, process 800 may include determining a value of the one or more items of value to be exchanged for the crypto-token. For example, if a first amount of the crypto-token is to be exchanged for a second type of cryptocurrency, the value of the second type of cryptocurrency may be determined. In some implementations, the value of the second type of cryptocurrency may be determined relative to the crypto-token. In an example implementation in which the request involves an exchange for one or more goods or services, the value of the one or more items of value (i.e., the one or more goods or services) may be determined by obtaining an invoice or receipt for the one or more goods or services.

In an operation 806, process 800 may include processing an exchange of the crypto-token for the one or more items of value based on the face value of the crypto-token. For example, an exchange of a portion of the amount of the crypto-token indicated in the request for another cryptocurrency, other currency, one or more goods or services, and/or other item(s) of value may be processed based on the determined value of the other cryptocurrency, other currency, good or services, and/or other item(s) of value. In the foregoing example, the request may comprise an attempt to exchange the crypto-token below its face value. In another example, an exchange of the amount of the crypto-token indicated in the request for a portion of the other cryptocurrency, other currency, and/or other item of value indicated in the request may be processed based on the determined value of the other cryptocurrency, other currency, and/or other item of value. In the foregoing example, the request may comprise an attempt to exchange the crypto-token above its face value. In various implementations, the exchange of a first type of cryptocurrency for a second type of cryptocurrency is processed via a smart swap exchange. For example, one or more graphical user interfaces may be generated that are configured to receive user input indicating an amount of a first type of cryptocurrency to be exchanged and a second type of cryptocurrency to be received. In some implementations, processing the exchange of a first type of cryptocurrency via a smart swap exchange may comprise identifying a user willing to trade an amount of the second type of cryptocurrency for at least a portion of the amount of the first type of cryptocurrency that the requesting user is attempting to exchange for the second type of cryptocurrency.

In an operation 808, process 800 may include preventing an exchange of the crypto-token for another cryptocurrency, other currency, and/or other item(s) of value where it represents an exchange above or below the face value of the crypto-token. For example, in an instance in which the request comprises an attempt to exchange the crypto-token below its face value, the excess portion of the amount of the crypto-token to be exchanged may be returned, thereby ensuring the crypto-token is not exchanged below its face value. In an instance in which the request comprises an attempt to exchange the crypto-token above its face value, the excess portion or amount of the other cryptocurrency, currency, or item(s) of value to be exchanged for the crypto-token may be returned, thereby ensuring the crypto-token is not exchanged above its face value. In various implementations, preventing the exchange of a first type of cryptocurrency for another type of cryptocurrency, other currency, and/or other item(s) of value where it represents an exchange above or below the face value of the crypto-token may comprise automatically returning the remaining (unexchanged) portion of the amount of the first type of cryptocurrency to the wallet associated with the request.

For purposes of explanation, numerous specific details are set forth in order to provide a thorough understanding of the description. It will be appreciated by those having skill in the art that the implementations described herein may be practiced without these specific details or with an equivalent arrangement. Accordingly, it is to be understood that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

In some instances, well-known structures and devices are shown in block diagram form in order to avoid unnecessarily obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses, and advantages of the invention will be apparent to those skilled in the art from consideration of the specification and practice of the invention disclosed herein. The specification should be considered exemplary only, and the scope of the invention is accordingly intended to be limited only by the following claims.

The various instructions described herein are exemplary only. Other configurations and numbers of instructions may be used, so long as the processor(s) are programmed to perform the functions described herein. The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, node 110 may be programmed by one or more additional instructions that may perform some or all of the functionality attributed herein to one of the instructions.

The various instructions described herein may be stored in a storage device of a given node 10 or webhost, which may comprise random access memory (RAM), read only memory (ROM), and/or other memory. For example, one or more storage devices 214 may comprise any tangible computer readable storage medium, including random access memory, read only memory, magnetic disk storage media, optical storage media, flash memory devices, and/or other memory configured to store the cryptocurrency protocol 210 (“CP 210”), which may include a protocol agent that automatically executes a smart contract 224. In various implementations, one or more storage device 214 may be configured to store one or more electronic blockchain-based smart contracts (e.g., smart contract(s) 224), wherein the smart contracts comprise computer code configured to execute conditional logic, as described herein. The storage device may store the computer program instructions (e.g., the aforementioned instructions) to be executed by the processors as well as data that may be manipulated by the processors. The storage device may comprise floppy disks, hard disks, optical disks, tapes, or other storage media for storing computer-executable instructions and/or data.

One or more databases may be used by, for example, system components outside the blockchain. The databases described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The various processing operations and/or data flows depicted in FIG. 8 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

Although described herein as an improved technology for stabilizing the value of a cryptocurrency, the systems and methods may be used to stabilize other types of electronic units of value that are not centrally managed by, for example, a central bank.

1. A computer-implemented system configured to implement an improved cryptocurrency stability protocol, the system comprising:
a memory configured to store one or more electronic smart contracts, wherein the one or more electronic smart contracts encode automatically executing computer program instructions configured to implement rules for a stable cryptocurrency; and
one or more physical computer processors configured by the computer program instructions to:
receive a request to exchange a first type of cryptocurrency in a digital wallet associated with the request for one or more items of value, wherein the request includes an indication of an amount of the first type of cryptocurrency to be exchanged for the one or more items of value;
determine a value of the one or more items of value;
process an exchange of a portion of the amount of the first type of cryptocurrency representing the value of the one or more items of value based on the request; and
prevent an exchange of a remaining portion of the amount of the first type of cryptocurrency based on a determination that the amount of the first type of cryptocurrency exceeds the value of the one or more items of value.

2. The system of claim 1, wherein to prevent the exchange of the remaining portion of the amount of the first type of cryptocurrency, the one or more processors are further configured to:
automatically return the remaining portion of the amount of the first type of cryptocurrency to the digital wallet associated with the request, wherein the remaining portion comprises the difference in value between the one or more items of value and the amount of the first type of cryptocurrency.

3. The system of claim 1, wherein the one or more items of value comprise an amount of a second type of cryptocurrency, wherein the value of the one or more items of value comprises a value of the second amount of the second type of cryptocurrency.

4. The system of claim 1, wherein the one or more items of value comprise one or more goods or services, wherein to determine the value of the one or more items of value, the one or more processors are further configured to:
obtain an invoice or receipt for the one or more goods or services.

5. The system of claim 1, wherein the first type of cryptocurrency comprises the stable cryptocurrency, and wherein each request to transfer the first type of cryptocurrency is automatically received by a smart contract configured to implement the improved cryptocurrency protocol, the one or more electronic smart contracts including at least the smart contract.

6. The system of claim 5, wherein the smart contract configured to implement the improved cryptocurrency protocol automatically prevents the first type of cryptocurrency from being exchanged above or below its face value.

7. The system of claim 1, wherein the one or more items of value comprise a second type of cryptocurrency, wherein the one or more processors are further configured by computer readable instructions to:
generate one or more graphical user interfaces configured to receive user input indicating the amount of the first type of cryptocurrency to be exchanged and the second type of cryptocurrency to be received; and
identify a user willing to trade an amount of the second type of cryptocurrency for at least the portion of the amount of the first type of cryptocurrency.

8. The system of claim 7, wherein the one or more graphical user interfaces do not enable a user to indicate a value at which to exchange the amount of the first type of cryptocurrency.

9. The system of claim 7, wherein the one or more graphical user interfaces do not enable a user to indicate an amount of the second type of cryptocurrency to be received.

10. The system of claim 7, wherein the exchange of the portion of the amount of the first type of cryptocurrency representing the value of the second type of cryptocurrency is processed via a smart swap exchange.

11. A method for implementing an improved cryptocurrency stability protocol, the method being implemented in a computer system having one or more physical computer processors and a memory configured to store one or more electronic smart contracts, wherein the one or more electronic smart contracts comprise automatically executing computer code configured to implement rules for a stable cryptocurrency, and wherein the one or more physical computer processors are configured by the computer code of the stored one or more electronic smart contracts to perform the method, the method comprising:
receiving a request to exchange a first type of cryptocurrency in a digital wallet associated with the request for one or more items of value, wherein the request includes an indication of an amount of the first type of cryptocurrency to be exchanged for the one or more items of value;
determining a value of the one or more items of value;
processing an exchange of a portion of the amount of the first type of cryptocurrency representing the value of the one or more items of value based on the request; and
preventing an exchange of a remaining portion of the amount of the first type of cryptocurrency based on a determination that the amount of the first type of cryptocurrency exceeds the value of the one or more items of value.

12. The method of claim 11, wherein preventing the exchange of the remaining portion of the amount of the first type of cryptocurrency comprises:
automatically returning the remaining portion of the amount of the first type of cryptocurrency to the digital wallet associated with the request, wherein the remaining portion comprises the difference in value between the one or more items of value and the amount of the first type of cryptocurrency.

13. The method of claim 11, wherein the one or more items of value comprise an amount of a second type of cryptocurrency, wherein the value of the one or more items of value comprises a value of the second amount of the second type of cryptocurrency.

14. The method of claim 11, wherein the one or more items of value comprise one or more goods or services, wherein determining the value of the one or more items of value comprises:
obtaining an invoice or receipt for the one or more goods or services.

15. The method of claim 11, wherein the first type of cryptocurrency comprises the stable cryptocurrency, and wherein each request to transfer the first type of cryptocurrency is automatically received by a smart contract configured to implement the improved cryptocurrency protocol, the one or more electronic smart contracts including at least the smart contract.

16. The method of claim 15, wherein the smart contract configured to implement the improved cryptocurrency protocol automatically prevents the first type of cryptocurrency from being exchanged above or below its face value.

17. The method of claim 11, wherein the one or more items of value comprise a second type of cryptocurrency, the method further comprising:
generating one or more graphical user interfaces configured to receive user input indicating the amount of the first type of cryptocurrency to be exchanged and the second type of cryptocurrency to be received; and
identifying a user willing to trade an amount of the second type of cryptocurrency for at least the portion of the amount of the first type of cryptocurrency.

18. The method of claim 17, wherein the one or more graphical user interfaces do not enable a user to indicate a value at which to exchange the amount of the first type of cryptocurrency.

19. The method of claim 17, wherein the one or more graphical user interfaces do not enable a user to indicate an amount of the second type of cryptocurrency to be received.

20. The method of claim 17, wherein the exchange of the portion of the amount of the first type of cryptocurrency representing the value of the second type of cryptocurrency is processed via a smart swap exchange.
